(19) United States
(12) Patent Application Publication
(10) Pub. No.: US 2025/0348493 A1
(43) Pub. Date: Nov. 13, 2025

(54) PERFORMING DISTRIBUTED JOINS USING COMPUTE EXPRESS LINK (CXL) IN DATABASE MANAGEMENT SYSTEMS

(71) Applicant: Actian Corporation, Round Rock, TX (US)

(72) Inventors: Steffen KLÄBE, IImenau (DE); Stephan BAUMANN, IImenau (DE); Alexander BAUMSTARK, Erfurt (DE); Kai-Uwe SATTLER, IImenau (DE); Marcus PARADIES, Erfurt (DE)

(21) Appl. No.: 19/204,056

(22) Filed: May 9, 2025

Related U.S. Application Data
(60) Provisional application No. 63/645,716, filed on May 10, 2024.

(51) Int. Cl. G06F 16/2455; G06F 13/16; G06F 16/27

(52) U.S. Cl. CPC G06F 16/2456; G06F 13/1673; G06F 16/278

(57) ABSTRACT

Aspects described herein relate to performing a distributed join in a database system using computer express link (CXL) memory. A first host device of multiple host devices can access the CXL memory to obtain data written to the CXL memory by at least a second host device of the multiple host devices. The first host device can perform, based on the obtained data, the distributed join.

### CLAIM OF PRIORITY UNDER 35 U.S.C. § 119

The present Application for Patent claims priority to Provisional Patent Application No. 63/645,716, entitled “TECHNIQUES FOR PERFORMING DISTRIBUTED JOINS” filed May 10, 2024, which is assigned to the assignee hereof and hereby expressly incorporated by reference herein for all purposes.

### FIELD

The disclosure relates to databases.

### BACKGROUND

Scaling out computation and memory with Massively Parallel Processing (MPP) is one solution to overcome the memory wall in database management systems (DBMSs). Computation can be efficiently parallelized by connecting memory and CPUs of multiple systems. As such, distributed DBM Ss can manage data over multiple systems in this regard. Such a configuration, however, can shift the problem towards data transfer between distributed CPUs as the main bottleneck. Traditional approaches for data exchange in distributed DBMSs rely on network-based implementations, which often experience high latency and require careful algorithm design to achieve fast communication and low latency. For example, distributed partitioned joins are one of the most expensive operators in distributed DBM Ss where a major part of the execution is attributed to network transfer costs. Although high-speed network technologies, such as remote direct memory access (RDMA), can lower this cost, they still come with significantly higher latency than local dynamic random access memory (DRA M) access.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an aspect, a computer-implemented method for performing a distributed join in a database system that includes multiple host devices is provided that includes accessing, by a first host device of the multiple host devices, a compute express link (CXL) memory to obtain data written to the CXL memory by at least a second host device of the multiple host devices, and performing, by the first host device and based on the obtained data, the distributed join.

In another aspect, a device for performing a distributed join in a database system that includes multiple host devices is provided that includes one or more memories configured to store instructions, and one or more processors communicatively coupled with the one or more memories. The one or more processors are configured to access a CXL memory to obtain data written to the CXL memory by at least a second device of the multiple host devices, and perform, based on the obtained data, the distributed join.

In another aspect, a computer-readable medium including code executable by one or more processors for performing a distributed join in a database system that includes multiple host devices is provided. The code includes code for accessing, by a first host device of the multiple host devices, a CXL memory to obtain data written to the CXL memory by at least a second host device of the multiple host devices, and performing, by the first host device and based on the obtained data, the distributed join.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

FIG. 1 illustrates an example of a compute express link (CXL) architecture for a distributed database management system (DBM S), in accordance with aspects described herein;

FIG. 2 illustrates an example of a CXL software runtime and an example of a CXL internal memory organization, in accordance with aspects described herein;

FIG. 3 illustrates examples of strategies for communication using CXL shared memory, in accordance with aspects described herein, in accordance with aspects described herein;

FIG. 4 illustrates an example of a data exchange procedure between two hosts, in accordance with aspects described herein;

FIG. 5 is a flowchart of an example of a method for performing distributed joins using CXL, in accordance with aspects described herein;

FIG. 6 is a flowchart of an example of a method for storing data using CXL for performing distributed joins, in accordance with aspects described herein;

FIG. 7 presents an example system diagram of various hardware components and other features, for use in accordance with aspects of the present disclosure; and

FIG. 8 is a block diagram of various example system components, for use in accordance with aspects of the present disclosure.

### DETAILED DESCRIPTION

Aspects described herein relate to performing distributed joins in a database management system (DBM S) using compute express link (CXL) for communication and/or data exchange between multiple systems (also referred to herein as compute nodes or hosts) of the DBM S. CXL is an open standard interconnect for efficient communication between the CPU and devices like accelerators, memory buffers, input/output (I/O) devices, etc. In addition to influencing architecture of upcoming systems, the CXL specification may also provide solutions to challenges associated with conventional distributed DBM Ss. Peripheral component interconnect-express (PCIe) can be used to carry load and store semantics, which can allow inter-host communication to be conducted similarly to intra-host communication, reducing the overall complexity and potentially enhancing performance. Latency or bandwidth differences in hardware can substantially affect performance, which can be mitigated by adapting to CXL characteristics. In an example, CXL 3.0 can offer low-latency, memory-semantic communication, allowing interconnected hosts peer-to-peer (P2P) communication and shared memory. The emerging CXL interconnect protocol promises to provide direct and cache-coherent access to remote memory while offering byte-addressable memory access without CPU intervention.

Moreover, the transition from traditional distributed architectures to shared memory with CXL can be accompanied by a paradigm shift from a distributed sender/receiver model to a shared or disaggregated memory model. This shift can entail managing CXL memory, inter-host synchronization, data placement, and/or different access patterns for higher latencies. In addition, CXL can integrate cache coherence with cache line granularity access over PCIe, which can reduce overhead and complexity. The current development of CXL may be moving towards an intra-rack solution that may use interconnects between racks of compute nodes for inter-rack communication.

Aspects described herein relate to leveraging CXL for engine-internal communication and data exchange in a distributed DBMS. In particular, for example, CXL communication strategies can be applied to distributed joins. In one example, existing MPP systems can be seamlessly adapted to CXL, and distributed joins can benefit from using CXL for communication and/or data exchange. For example, distributed joins are significantly influenced by the hardware characteristics of the interconnect linking the distributed hosts.

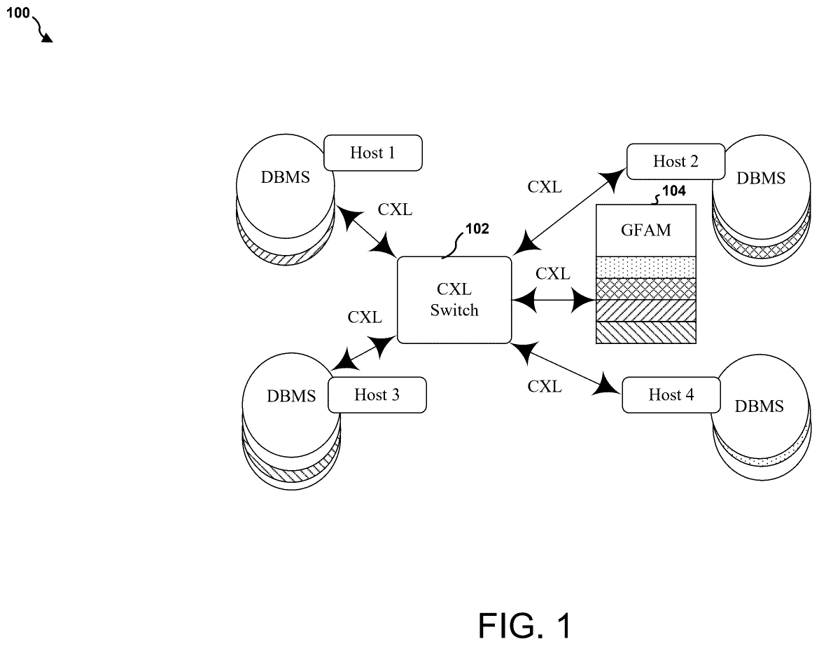

FIG. 1 illustrates an example of a CXL architecture 100 for a distributed DBMS, in accordance with aspects described herein. In CXL architecture 100, several hosts (Host 1, Host 2, Host 3, Host 4) are interconnected via a CXL switch 102 and share memory using the global fabric attached memory (GFAM) 104 feature of CXL 3.0, such that the GFAM can include a portion of DBMS in memory shared by the associated host using CXL. A CXL architecture can allow for communication and data exchange of CXL to be used for the distributed joins. Various characteristics can impact distributed join algorithm performance, e.g., the processing performance of data structures like hash tables is influenced by latency, and transfer throughput by the interconnect bandwidth. Using CXL for communication and data exchange can decrease latencies associated with distributed join algorithm performance.

Distributed DBM Ss commonly use data partitioning to distribute work among hosts and enable parallel and distributed query processing. Data is typically either pre-partitioned (e.g., using hash, range, or random partitioning) or partitioned on the fly (e.g., in executing a join). Joining partitioned data must ensure correctness as join partners in distributed DBM Ss may be located in different partitions (and on different hosts). Data co-partitioning and co-location can help to avoid data transfer and achieving fast query execution. For hash partitioning, data co-partitioning of two tables can be achieved by choosing the join key as the partitioning key, and for range partitioning one can choose the same ranges on the join columns to ensure that all join partners are assigned to the same partition. While one can try to co-locate tables that are frequently joined together, designing a partitioning schema for a whole database schema can be challenging [5, 14] and the partitions may still contain pairs of tables that are not co-located.

One example approach for performing hash joins for distributed DB M Ss when the build and probe sides are not co-partitioned is a Repartition Hash Join (R-HJ). R-HJ can enforce the partition requirement by repartitioning both join sides on the join keys if needed. Subsequently, both sides can be co-located and the join can be independently performed on these partitions without further data exchange. The resulting table can be partitioned according to the join keys.

Another example approach for performing hash joins for distributed DBM Ss when the build and probe sides are not co-partitioned is a Broadcast Hash Join (BC-HJ). In a BC-HJ, the build side of the join can be broadcasted to be available to all workers participating in the join. After broadcasting, independent hash tables can be built on each worker (e.g., on each compute node) and independently probed. This approach is typically reasonable if the build side is small or not partitioned. The result is a table partitioned according to the probe side.

Another example approach for performing hash joins for distributed DB M Ss when the build and probe sides are not co-partitioned is a Shared Hash Table Hash Join (SHT-HJ). In a SHT-HJ, a shared hash table is built in shared memory and can be concurrently probed. Shared memory access granularity may vary in implementations from highly concurrent access of single hash table inserts towards building local hash tables and merging them into shared memory. The resulting table can be partitioned according to the probe side.

The DBMS can perform an optimizer decision between these approaches in performing a distributed join in a given use case. The decision may be complex and can depend on many factors, such as the number of distinct join keys of the probe side (determining the number of hash table collisions), the size of the probe side (BC-HJ and SHT-HJ do not repartition the probe side at all), the distribution of the probe side (skewness of the partition key vs. the join key), etc. Moreover, subsequent operations might push a partitioning requirement on the join, i.e., subsequent repartitioning might be avoidable depending on the partitioning of the join result. If applied to a distributed DBM S, these approaches may require data exchange or concurrently working on shared memory. Using CXL memory for performing distributed joins can improve performance thereof, as described further herein.

Distributed joins aim to enhance parallel processing by utilizing the resources of multiple hosts, and resulting performance can benefit from careful implementation based on the underlying system architecture. Parallel joins can benefit from additional caching layers, and CXL can be seen as a caching layer in this regard. CXL defines several interconnect protocols between processors and different device types built upon PCIe. CXL version 1.0 specifies three device types and three protocols: CXL.io for PCIe-based I/O setup, CXL.mem for memory access via PCIe-carried load/store operations, and CXL.cache for cache-coherent access across CXL devices. CXL 2.0 adds CXL switch support, allowing hosts to extend and manage CXL devices within a single hierarchy and introduces memory pooling to multiple host processors. CXL 3.0 expands cache-coherency semantics for Type 2 and 3 devices to facilitate peer-to-peer communication and memory sharing of the same segment among multiple devices within a cache-coherency domain. The specification supports fabric topologies connecting multiple hosts with Global Fabric Attached Memory (GFAM). GFAM allows disaggregated memory and networking between multiple hosts and devices where the communication can be encapsulated in PCIe messages. CXL 3 can use PCIe 6.0, doubling the bandwidth (121 giga bytes (GB)/s×16) compared to CXL 2.0 (63 GB/s×16). CXL 3.0 specification can also provide cache-coherent P2P communication and shared memory via GFAM.

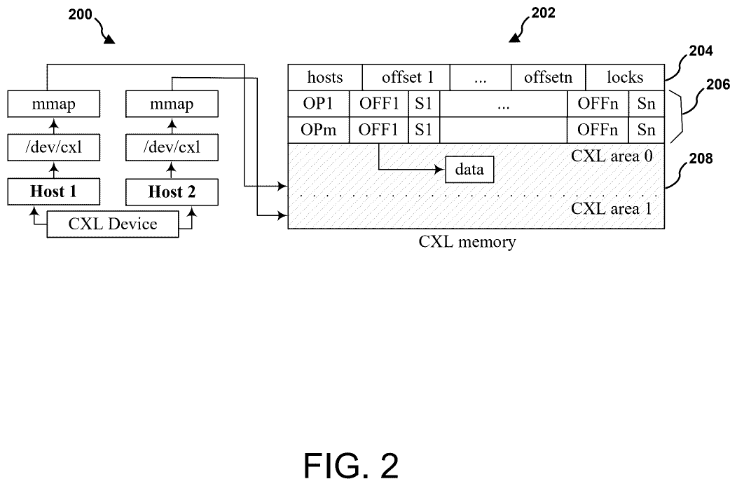

In some examples described herein, CXL Type 3 devices can function as headless remote non-uniform memory access (NUMA) nodes, allowing memory expansion devices (Type 3) to integrate additional host-managed device memory (HDM) as main memory. HDM can also operate as a direct access (DAX) device, enabling direct memory management similar to PMem devices. An example is shown in FIG. 2.

FIG. 2 illustrates an example of a CXL software runtime 200 and an example of a CXL internal memory organization 202, in accordance with aspects described herein. Using a Linux Kernel, for example, CXL devices can be exposed as device entries, enabling the creation of CXL regions using the cxlctl tool. Subsequently, daxctl can be used to configure the HDM as a devdax device. Access to the HDM can be facilitated through the exposed path, such as/dev/cxl. With this, mmap can be utilized to map the HDM to the virtual address space of an application. When connected with other hosts (with CXL 3.0), the same device can be accessed in this way, both hosts using mmap

In one example, the HDM can be managed at the application layer. CXL shared memory can be managed equally by all host devices. In accordance with aspects described herein, a header 204 can be placed at a first number of bytes in the CXL shared memory device, as shown in FIG. 2. The header 204 can include one or more parameters, such as an indication of a number of host devices in the distributed DB MS, an indication of initial offsets of free memory areas at the CXL shared memory device, parameters related to or for maintaining synchronization mechanisms (e.g., spinlocks or barriers, a reference counter, etc.) for each area, or data access tables (DAT) 206 information for each area, etc. For example, the reference counters can be used by incrementing a reference counter when a reading process begins and decrementing the reference counter when the reading process ends. A host writing data to the area of the CXL memory can check the reference counter to ensure no reading processes are active before writing to the area of the CXL memory. The remaining CXL memory 208 can be shared globally or allocated among the host devices; however, the applications can be responsible for the management, e.g., there may be no protection of read/write access, and/or synchronization may be used for concurrent access.

In some aspects described herein, CXL shared memory acts as a remote NUMA node with uniform NUMA distance for all hosts. This arrangement can permit atomic operations within an exclusive cache line by a host, visible to other hosts, such that all reads and writes can conform to cache line sizes (GFAM and global integrated memory (GIM)). Cache coherency can be used ensured across a single hierarchy supporting at least 2-4 hosts through CXL, utilizing CXL.mem and CXL.cache. CXL 2.0 can use an additional software cache coherence protocol. Direct host-to-host communication may be possible with shared memory as the medium for interaction, e.g., where there is sufficient available memory for host-to-device and/or device-to-host data transfers.

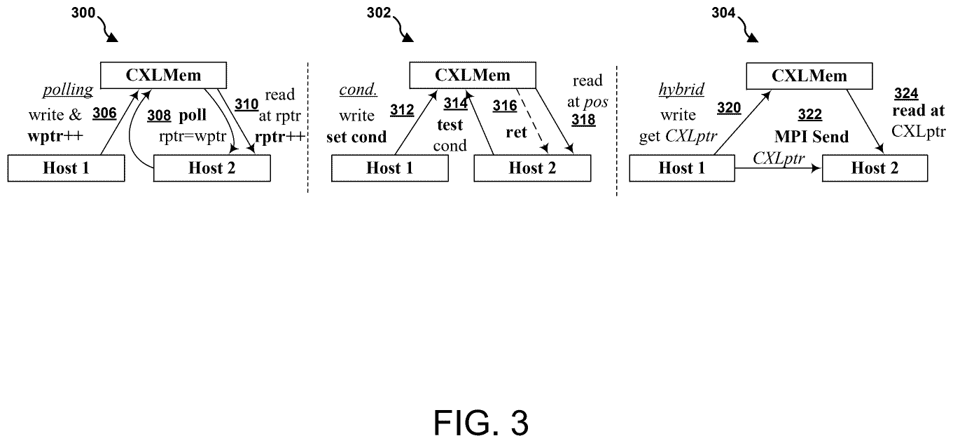

With CXL, communication between hosts can rely on memory semantics to interact with remote shared memory. In accordance with aspects described herein, strategies can be used to ease communication and data transfer among hosts connected via a shared CXL memory device. An example of such strategies is shown in FIG. 3. These strategies map the communication model of MPI into CXL shared memory.

FIG. 3 illustrates examples of strategies 300, 302, and 304 for communication using CXL shared memory, in accordance with aspects described herein. At 300, a polling strategy is depicted, where local read pointers and shared write pointers can be repeatedly checked in a loop for a change in CXL memory. When a host writes to CXL memory, the host can increment a write pointer in CXL, at 306. Polling hosts can detect a change by comparing a read pointer to the write pointer at 308 (e.g., based on whether a read pointer at the polling host matches a write pointer set by the writing host). If so, the polling hosts can read the data, and/or can increment their local pointers at 310. Polling can be used and/or can be effective for scenarios with frequent message transfers between hosts, especially when only a few iterations are used for notification. This strategy can be employed once communication has initiated and data is processed in CXL shared memory.

At 302, a conditional strategy is depicted that can utilize a condition variable in CXL to check for changes in CXL memory, reducing the need for continuous checking. When there are no changes (e.g., when the condition variable indicates no changes), the thread executing on the host can proceed with other tasks. Based on writing data (or a message) to the CXL memory, the writing host can notify by setting the condition variable at 312. The other hosts can detect the change based on periodically checking the condition variable at 314. The condition variable is returned at 316, and if the value of the condition variable indicates data is written, the other hosts can read the data at the associated position in memory at 318. Using a condition variable for shared memory communication in this regard can be advantageous in infrequent communication scenarios or for initiating intra-host communication. Additionally, the condition variable approach can be employed to synchronize access to a shared resource, serving as a lock.

At 304, a Hybrid MPI/CXL strategy is depicted where an MPI approach can be combined with CXL by using MPI to notify other hosts of changes. In this example, initially, a host can write data to CXL memory at 320. The host can then use MPI to send a pointer (e.g., as an offset) pointing to the written CXL data to other hosts at 322. Receiving hosts can read the data through the received pointer at 324. The hybrid MPI/CXL strategy can be advantageous for initiating communication between hosts, such as launching distributed queries. Placing the data in CXL memory can reduce message size, as only the pointer is sent. In one example, the hybrid approach can be used for host orchestration and management, specifically for exchanging the number of available hosts and additional execution parameters.

In some examples, data in CXL memory can be accessed by host-to-device (H2D), by device-to-host (D2H) transfer, or directly through pointers. The CXL specification can guarantee that host-initiated atomic operations can be observed by other hosts. This can enable the implementation of various synchronization primitives, similar to those used in standard concurrent synchronization. For example, locks can be implemented as spinlocks using compare-and-swap and barriers based on an atomic counter and fetch-and-add operation.

In some examples, on the local host side, each host can manage a CXL context by itself. The CXL area can be managed with DAT 206, as shown in FIG. 2. The individual identifier of a host can be assigned at startup and/or communicated via MPI. Shared data in CXL memory can be sequentially organized (i.e. as a ring buffer) where individual data can be accessed by DAT entries storing the offsets and sizes of individual data. Further, read and write pointers can be stored in CXL memory for each area. A host-managed CXL context, along with its read and write pointers, can enable identification of newly written data by other hosts.

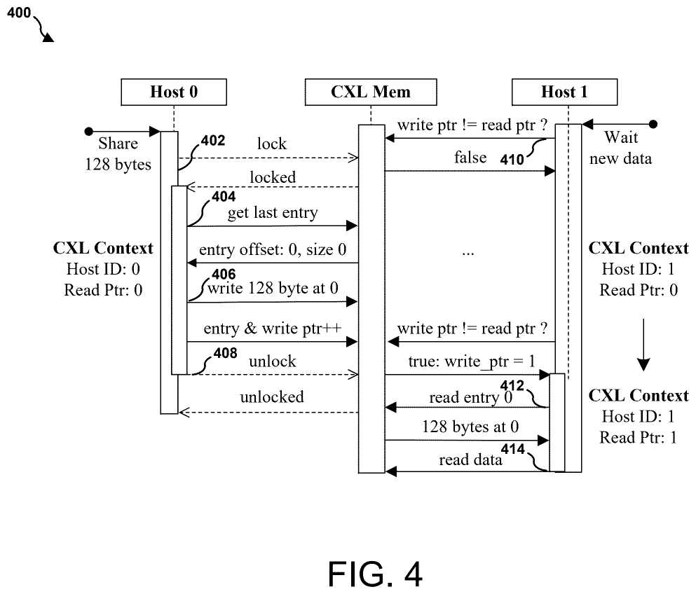

FIG. 4 illustrates an example of a data exchange procedure 400 between two hosts, in accordance with aspects described herein. For example, to share data, a host can acquire a lock to write data to a specific CXL area at 402 before reading the last written entry in the DAT using the write pointer of the CXL area at 404. Then, the host can write the data to the appropriate offset, determined by adding the size to the last written offset at 406. The header of the area can be updated at the end, and the lock can be released at 408. To read the recent data, a host can compare its local read pointer with the read pointer of the relevant area at 410. If matching (e.g., the write pointer is not equal to the read pointer), the host can read the data at its read pointer at 412, increment the read pointer, and/or continue reading data at 414 until a termination message is encountered. The sender can signal termination through a final message.

In conventional distributed DBM Ss, the data exchange process can be a primary bottleneck, particularly when considering join algorithms in a distributed setting. For example, individual hosts must wait for data from other hosts, which can exacerbate the bottleneck with the use of slow interconnects, frequent protocol conversions, data serialization, etc. CXL can leverage PCIe to provide high bandwidth and low latency and can offer memory-like access capabilities, which can mitigate these challenges. In accordance with aspects described herein, distributed join algorithms can be performed in a multi-host setup connected by CXL shared memory. For example, each host can execute a database node with one or more worker threads (also referred to herein as workers), leveraging the approaches described for inter-host communication. The CXL memory area can be organized as described in reference to FIG. 2 at 202, above, and structured by the number of participating hosts referred to as CXL areas (allowing GFAM or GIM). Each area can be (logically) assigned to a single host during query setup. The CXL areas can each include a header and a separate DAT for each operator pair (sending host, receiving host) of a join, which can simplify the identification of data belonging to an operator.

In a Repartition Hash Join, for example, data in distributed DBM Ss can be partitioned over all (or at least a portion of) participating hosts. Executing a partitioned hash join can result in repartitioning the data (R-HJ). The phases of this algorithm can include (1) Repartitioning of both joins sides on join keys, (2) data exchange of partitions to the appropriate nodes, and (3) join on local partitions. During the Repartitioning Phase, for example, both join sides can be repartitioned such that tuples with matching join keys result in the same partition. After co-location, these partitions can be independently processed. Partitioning can be done by selecting tuples by the join keys of both join sides. Selected tuples can be serialized and inserted into one or multiple buffers to prepare them before the actual data exchange. Serialization can be used as host-local data may not be directly accessed from other hosts. Each buffer can be tagged by an operator and a host identifier to determine the belonging data. Additionally, the count of tuples inserted can be placed in the initial bytes of the buffer (e.g., in the header), offering additional information to the receiver.

During the Data Exchange Phase, a sender-receiver model implemented via the polling approach in CXL for data exchange, described above, can be used. The query optimizer can enforce the communication pairs of the individual partitions, the number of sender/receiver threads per operator, and/or the number of buffers per operator, etc. On the sending side, when the data is partitioned according to the Repartitioning Phase described above, the partitions (buffers) can be transferred to their determined destination(s). Sending of data can be performed by writing data directly into the assigned CXL area of the destination host. This can allow hosts to communicate via CXL shared memory and can reduce additional synchronization for concurrent access. To perform the exchange via CXL, the sending host can lock the CXL area (e.g., by setting a lock parameter value in the header of the CXL area) and can perform the data exchange procedure as described above. For optimal performance, in an example, distributed join algorithms can consider the hardware access latency. In one example, tuples for a particular partition can either be placed directly on an allocated buffer in CXL (referred to herein as CXL-direct (CXL-D)) or beforehand a host local buffer and copied afterward to CXL memory (referred to herein as CXL-copy (CXL-C)). For CXL-D, buffers can be allocated using cxl_malloc similar to the usual malloc but can return a pointer to CXL memory. Data for the buffer can be directly written using memcpy. With CXL-C, the data can be first copied to local memory and afterward as one single transfer with cxl_memcpy to CXL shared memory. This function can additionally manage the DAT of the CXL area.

In one example, CXL-D or CXL-C can be selected depending on the size and resulting access latency of the CXL memory. When the transfer of tuples to the CXL buffer is complete, the DAT entry with offset position and size can be inserted (e.g., in the header associated with the CXL area) and the write pointer of this CXL area header can be increased, indicating available data for participating hosts. The cache line of the sender can be flushed to make changes visible to other hosts. This can be performed for all buffers. Subsequently, a final buffer without tuples can be placed in CXL, including the number of buffers sent to indicate the end of the transfer.

On the receiving side, the hosts can poll the CXL area for changes that start directly at query execution. This can be done by iteratively by comparing the read pointer of the hosts' CXL context with the write pointer in the CXL area header, as described above. Whenever a change is detected, the buffer can either be read directly (e.g., using CXL-D) or copied to a host local buffer (e.g., using CXL-C). For example, as data can be concurrently sent by multiple senders, the order of the data can be mixed up. The receiver can obtain the belonging data through a tag inserted in the buffer. The hosts on the receiving side can poll until a termination message with the number of messages sent from the sender is obtained. After the data exchange, both join sides can be co-located and partitioned according to the join keys. The remaining join steps can be performed locally on the partitions without further data exchange. For example, for a repartition hash join, the receiving hosts can build a local hash table on one of the build partitions/collections in parallel and can probe the respective matching probe partition/collection. The results of the join can either be processed further or merged at later processing.

In another example, in a repartition join (without hashing), the receiving hosts can probe one of the build partitions/collections by looping over the build partition/collection for each tuple in the respective probe partition/collection.

In a Broadcast Hash Join, the build side can be generated and broadcast to all available hosts. The optimizer can select or enforce which build side is considered for the broadcast. The phases of the BC-HJ can include (1) Broadcast of the build side to participating hosts, (2) build of local hash tables, and (3) probe on local hash tables. In pure network-based solutions without CXL, broadcast data are transferred multiple times, degrading overall performance due to multiple copies. Using CXL with shared memory, however, can enable shared data placement directly accessible by other hosts. Instead of transferring buffers from one host to the assigned CXL memory area of the other hosts, like with the R-HJ, a broadcasting hosts can directly place the data in their assigned CXL memory area. One advantage of broadcasting via CXL shared memory can be that only one transfer per buffer is necessary. Broadcasting can be performed by multiple hosts when data is (pre) partitioned. If a host has no data to broadcast, it can place, in its CXL memory area, a termination message with 0 as the number of tuples sent. Similarly to R-HJ, transfers for broadcast hash join using CXL can be direct (CXL-D) or through copies from local buffers (CXL-C). With each host writing to its assigned CXL area, additional synchronization may not be needed, which can enhance parallelism. Receiving workers can collect the data from the other CXL areas (e.g., CXL areas of at least a portion of, or all of, the other hosts) to obtain the complete data. Collecting data can be performed by polling, as described above. As each worker maintains its CXL context and read pointers for all areas, new data can be recognized by comparing the read points with the write pointer of the CXL areas. To enhance polling response, the polling can include iterations over other areas in each cycle, allowing data access in CXL from the fastest host. The build and probe phase can start once a host reads (or otherwise based on the host reading) the final message from the sender(s). When the data exchange is complete and each host receives the data, the hosts can locally construct hash tables and probe the local probe side collection/partition against the local hash table. Hash table construction can utilize CXL-C or CXL-D, affecting build and probe performance based on CXL characteristics.

In another example, in a broadcast join (without hashing), the receiving hosts can probe the broadcasted build collection by looping over the build collection for each tuple of the device local probe collection.

In a Shared Hash Table Hash Join, hosts can directly operate on a hash table placed in CXL memory. The underlying hash table implementation can be built upon vectorization and/or chaining for collision resolution. In contrast to the Repartition Hash Join and the Broadcat Hash Join, the SHT-HJ can operate on a data structure allocated in CXL instead of memory buffers. This can imply a more fine-granular and frequent data access, which can be more affected by the CXL memory latency. The phases of SHT-HJ can include (1) Allocate a global hash table, (2) build the global hash table with workers, and (3) individual probing of the global hash table. During Hash Table Build, a barrier can be used to synchronize hash table allocation, with the first worker at the barrier allocating a global hash table in its CXL area via cxl_malloc. The optimizer can determine a suitable allocation size for the hash table. The barrier can block other hosts (and/or their workers) until the allocation is completed. Then, the hosts can iterate over the DAT of the CXL areas to find the allocated hash table. The allocated hash table can be the first entry of a DAT. Subsequent allocations by other hosts can extend the hash table and can be in the same CXL area which can be achieved by passing the appropriate area to cxl_malloc. Subsequently, one or more (or all workers) can begin with the building phase of the join. Locking the CXL area, where the hash table is allocated, can synchronize concurrent access when building the hash table in CXL memory. Intra-worker synchronization may not be necessary as every thread can work on different bucket ranges. The individual workers can work directly in CXL (CXL-D) or can create the buckets first in the host-local memory and copy them afterward to the main table (CXL-C). CXL-C can be useful when there are many tuples and a high CXL access latency. When the build is complete, the workers can copy their buckets from memory into CXL shared memory using cxl_memcpy. Both approaches may differ in data allocation and final merging in the case of CXL-C. In an example, pointers from main memory can be switched to CXL shared memory. This can prove the seamless integration of CXL shared memory into distributed DBM Ss. Each host can wait on a final barrier for other hosts to finish the build stage.

For probing in the Shared Hash Table Join, the hash table can be directly accessed in CXL memory (CXL-D) or copied to the local memory of the workers (CXL-C). As data is partitioned and co-located, different workers can operate on distinct ranges of buckets. Thus, transfer or access costs can be reduced.

A query often includes multiple joins executed on the results of respective previous joins. An implementation with MPI can provide extended communication by tagging messages, e.g., a message is tagged by operator and worker identifier to identify belonging tuples to an operator. When using CXL, each join operator can be assigned its own DAT 206, as described above with reference to FIG. 2. The number of DATs can be configured by the query optimizer. Workers of an operator can identify their belonging message from other hosts by accessing their specific DAT in the CXL area identified by the assigned operator identifier.

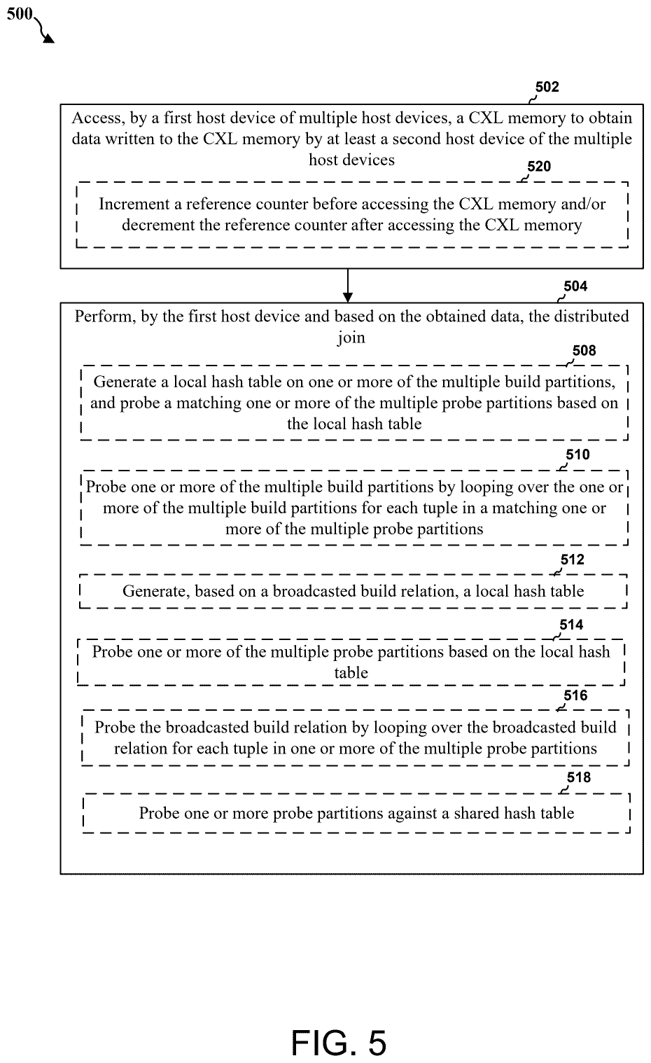

FIG. 5 is a flowchart of an example of a method 500 for performing distributed joins using CXL, in accordance with aspects described herein. The method 500 may be performed by one or more nodes of CXL architecture 100 or host devices in data exchange procedure 400, based on CXL software runtime 200 and/or internal memory organization 202, and/or based on one or more data communication strategies 300, 302, or 304, using one or more processors to execute corresponding instructions, one or more memories to store instructions or related information, etc.

At block 502, the method 500 may include accessing, by a first host device of multiple host devices in a distributed DBMS, a CXL memory to obtain data written to the CXL memory by at least a second host device of the multiple host devices. For example, the first host device (e.g., using one or more processors, one or more memories, etc.) can access the CXL memory to obtain data written to the CXL memory by at least the second host device of the multiple host devices. As described, for example, the first host device can access the CXL memory to obtain data for performing a repartition join or a broadcast join, for building a hash table as part of a distributed join (e.g., for a repartition hash join or a broadcast hash join), or can access the CXL memory to obtain the hash table (e.g., for a shared hash table hash join).

At block 504, the method 500 may include performing, by the first host device and based on obtained data, a distributed join. For example, the first host device (e.g., using one or more processors, one or more memories, etc.) can perform, based on the obtained data, the distributed join.

In one example, performing the distributed join can include performing a repartition join or a repartition hash join. In this example, the obtained data can correspond to at least one build partition of multiple build partitions or at least one probe partition of multiple probe partitions. As described, for example, where the distributed join is a repartition join, the first host device can participate in a data exchange with the second host device (and/or additional host devices) to store data to, or obtain data from, the CXL memory to repartition tuples based on a key value so tuples having the same key value are stored in the CXL area associated with the same host device. Once the tuples are repartitioned, the first host device can perform the repartition join.

Where the repartition join is a repartition hash join, for example, optionally at block 508, a local hash table can be generated on one or more of the multiple build partitions, and a matching one or more of the multiple probe partitions can be probed based on the local hash table. For example, the first host device (e.g., using one or more processors, one or more memories, etc.) can generate the local hash table on the one or more of the multiple build partitions (e.g., as obtained data from CXL memory) and can probe a matching one or more of the multiple probe partitions based on the local hash table to perform the distributed join. Though described as a single host device performing the functions described above, in a distributed repartition hash join, multiple (or all) host devices in the DBMS can similarly generate the local hash table on one or more of multiple build partitions and one or more of multiple probe partitions (e.g., as obtained from CXL memory) and/or can probe the matching one or more of the multiple probe partitions based on the local hash table.

Where the repartition join is a repartition join other than a hash join, for example, optionally at block 510, one or more of the multiple build partitions can be probed by looping over the one or more of the multiple build partitions for each tuple in a matching one or more of the multiple probe partitions. For example, the first host device (e.g., using one or more processors, one or more memories, etc.) can probe the one or more of the multiple build partitions (as stored in, and obtained from, the CXL memory) by looping over the one or more of the multiple build partitions for each tuple in the matching one or more of the multiple probe partitions (as stored in, and obtained from, the CXL memory) to perform the distributed join. Though described as a single host device performing the functions described above, in a repartition join, multiple (or all) host devices in the DBMS can similarly probe the one or more of multiple build partitions (as stored in, and obtained from, the CXL memory) by looping over the one or more of the multiple build partitions for each tuple in a matching one or more of the multiple probe partitions (as stored in, and obtained from, the CXL memory).

In one example, performing the distributed join can include performing a broadcast join or a broadcast hash join. In this example, the obtained data can correspond to a broadcasted build relation generated based on the multiple hosts writing the data to the CXL memory. The data can correspond to tuples that are related to one another by a join key. Where the distributed join is a broadcast hash join, optionally at block 512, a local hash table can be generated based on a broadcasted build relation. For example, the first host device (e.g., using one or more processors, one or more memories, etc.) can generate, based on the broadcasted build relation (e.g., as the data obtained from CXL memory), the local hash table. In this example, optionally at block 514, one or more of multiple probe partitions can be probed based on the local hash table. For example, the first host device (e.g., using one or more processors, one or more memories, etc.) can probe the one or more of the multiple probe partitions based on the local hash table to perform the distributed join. Though described as a single host device performing the functions described above, in a distributed broadcast hash join, multiple (or all) host devices in the DBMS can similarly generate the local hash table based on the broadcasted build relation (e.g., as the data obtained from CXL memory) and/or can probe the one or more of the multiple probe partitions based on the local hash table.

Where the broadcast join is a broadcast join other than a hash join, for example, optionally at block 516, the broadcasted build relation can be probed by looping over the broadcasted build relation for each tuple in one or more of the multiple probe partitions. For example, the first host device (e.g., using one or more processors, one or more memories, etc.) can probe the broadcasted build relation (as stored in, and obtained from, the CXL memory) by looping over the broadcasted build relation for each tuple in the one or more of the multiple probe partitions (as stored in, and obtained from, the CXL memory) to perform the distributed join. Though described as a single host device performing the functions described above, in a broadcast join, multiple (or all) host devices in the DBMS can similarly probe the broadcasted build relation (as stored in, and obtained from, the CXL memory) by looping over the broadcasted build relation for each tuple in one or more of the multiple probe partitions (as stored in, and obtained from, the CXL memory).

In another example, performing the distributed join can include performing a shared hash table hash join. In this example, the obtained data can correspond to a shared hash table stored in the CXL memory. For example, the host devices can write to CXL memory to generate a centralized hash table in the CXL memory. In this example, optionally at block 518, one or more probe partitions can be probed against the shared hash table. For example, the first host device (e.g., using one or more processors, one or more memories, etc.) can probe the one or more probe partitions against the shared hash table to perform the distributed join. Though described as a single host device performing the functions described above, in a shared hash table hash join, multiple (or all) host devices in the DBMS can similarly probe the one or more probe partitions against the shared hash table (as stored in, and obtained from, the CXL memory).

As described, various data exchange strategies can be employed using CXL. This can include use of synchronization mechanisms, such as spinlocks, barriers, reference counters, etc. In one example, accessing the CXL memory at block 502 can optionally include, at block 520, incrementing a reference counter before accessing the CXL memory and/or decrementing the reference counter after accessing the CXL memory. For example, the first host device (e.g., using one or more processors, one or more memories, etc.) can increment the reference counter before accessing the CXL memory and/or decrement the reference counter after accessing the CXL memory. Host devices writing or storing data to the CXL memory can accordingly check the reference counter before writing or storing the data, as described.

The data exchange strategies can include polling, conditional, hybrid, etc., as described. For example for polling, accessing the CXL memory to obtain data, at block 502, can include accessing the CXL memory based on determining that a write pointer in a data access table corresponding to an area of the CXL memory to be read matches a read point of the host device. In addition, accessing the CXL memory can also include checking a parameter for locking the area of the CXL memory (e.g., in a header 204 of the CXL memory) to determine that the area is unlocked. For example, for conditional, accessing the CXL memory to obtain data, at block 502, can include detecting that a test condition indicating that the second host device has written to the CXL memory is successful. For example, for hybrid, accessing the CXL memory to obtain data, at block 502, can include receiving a message from the second host device indicating that the second host device has written to the CXL memory, and/or accessing the area based on a write pointer indicated in the message. Moreover, for example, accessing the CXL memory to obtain data, at block 502, can include obtaining the data from a buffer allocated, in the CXL memory, to the second host device (for CXL-D) or copying a portion of contents of the CXL memory into a local memory of the first host device, and obtaining the data from the local memory (for CXL-C).

Similarly, for example, storing data in the CXL memory (e.g., at block 510, 512, or 514) can include detecting that the lock value for a portion or area of the CXL memory where the hash table is stored is set to an unlocked value, and/or can include setting the lock value to a locked value when storing the data and/or setting the lock value to an unlocked value based on storing being completed.

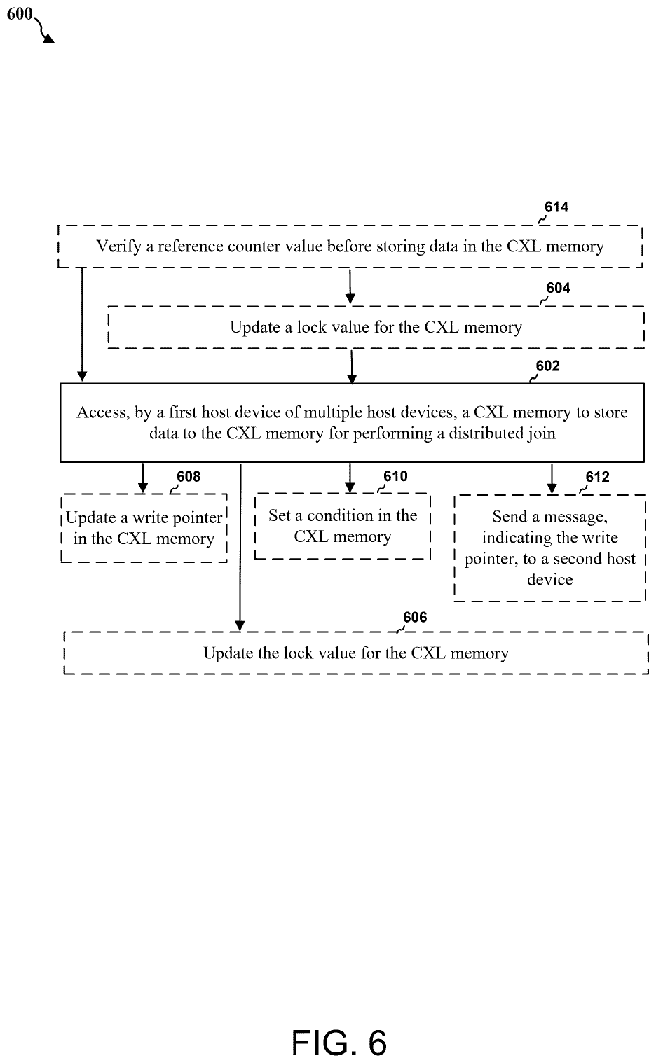

FIG. 6 is a flowchart of an example of a method 600 for storing data using CXL for performing distributed joins, in accordance with aspects described herein. The method 600 may be performed by one or more nodes of CXL architecture 100 or host devices in data exchange procedure 400, based on CXL software runtime 200 and/or internal memory organization 202, and/or based on one or more data communication strategies 300, 302, or 304, using one or more processors to execute corresponding instructions, one or more memories to store instructions or related information, etc.

At block 602, the method 600 may include accessing, by a first host device of multiple host devices in a distributed DBMS, a CXL memory to store data to the CXL memory for performing a distributed join (or for performing data exchange related to performing a distributed join). For example, the first host device (e.g., using one or more processors, one or more memories, etc.) can access the CXL memory to store the data to the CXL memory for performing the distributed join. For example, the first host device can store the data to an area of the CXL memory corresponding to the first host device. As described above, the data can include data from the first host device that contributes to repartitioning data based on a join key, building one or more build partitions or one or more probe partitions, and/or the like in a reparation join, data that contributes to a build relation for broadcasting in a broadcast join, a portion of a shared hash table in a shared hash table hash join, etc.

Optionally, at block 604, the method 600 may include updating a lock value for the CXL memory before the CXL memory is accessed to store the data. For example, the first host device (e.g., using one or more processors, one or more memories, etc.) can update the lock value for the CXL memory (e.g., for the area of the CXL memory corresponding to the first host device) to indicate the area is locked before accessing the area to store the data. For example, the first host device can update the lock value in the header 204 of the CXL memory, as described.

Optionally, at block 606, the method 600 may include updating a lock value for the CXL memory after the CXL memory is accessed to store the data. For example, the first host device (e.g., using one or more processors, one or more memories, etc.) can update the lock value for the CXL memory (e.g., for the area of the CXL memory corresponding to the first host device) to indicate the area is unlocked after accessing the area to store the data. For example, the first host device can update the lock value in the header 204 of the CXL memory, as described.

Optionally, at block 608, the method 600 may include (e.g., for data exchange via polling), updating a write pointer in the CXL memory. For example, the first host device (e.g., using one or more processors, one or more memories, etc.) can update the write pointer in the CXL memory to point to the data stored at block 602. This can notify polling host devices of the written data, and the polling host devices can accordingly read the written data from the area of the CXL memory, as described herein. In an example, the first host device can set the write pointer in a portion of the DAT 206 corresponding to the first host device (and/or to one or more host devices reading the CXL memory area associated with the first host device).

Optionally, at block 610, the method 600 may include (e.g., for data exchange via conditional), setting a condition in the CXL memory. For example, the first host device (e.g., using one or more processors, one or more memories, etc.) can set the condition in the CXL memory. This can allow host devices to check the condition, and read the written data when the condition is set, as described herein. In an example, the first host device can set the condition in a header 204 of the CXL memory.

Optionally, at block 612, the method 600 may include (e.g., for data exchange via hybrid), sending a message, indicating the write pointer, to a second host device. For example, the first host device (e.g., using one or more processors, one or more memories, etc.) can send the message, indicating the write pointer, to the second host device (and/or other host devices). This can notify the second host device(s) of the written data, and the second host device(s) can accordingly read the written data from the area of the CXL memory based on the indicated write pointer, as described herein.

Optionally, at block 614, the method 600 may include verifying a reference counter value before storing data in the CXL memory. For example, the first host device (e.g., using one or more processors, one or more memories, etc.) can verify the reference counter value before storing data in the CXL memory. This can prevent the host device from overwriting data while a reading host device is reading data from the same area of the CXL memory, as described above.

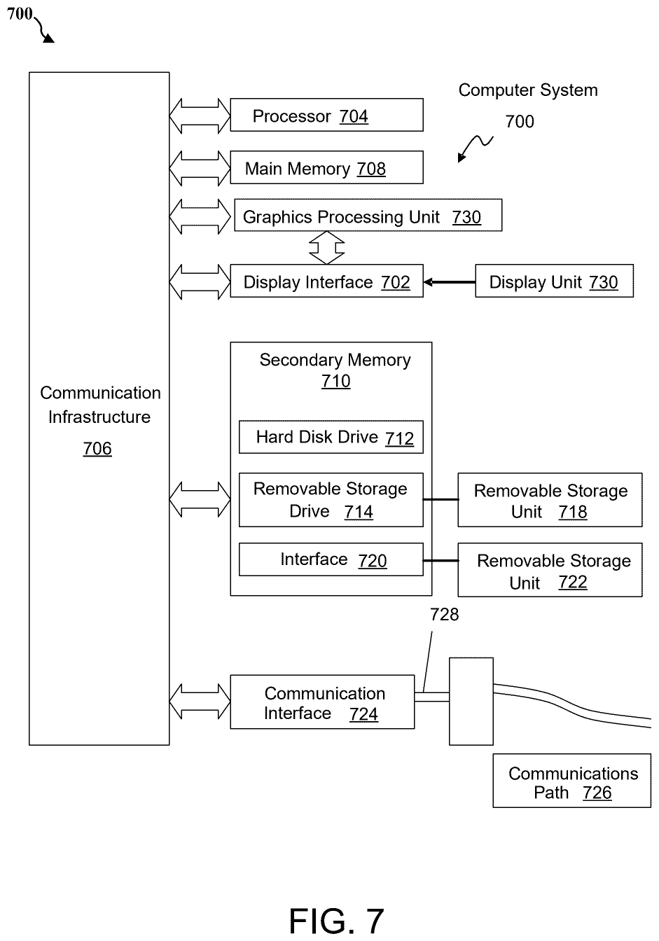

FIG. 7 presents an example system diagram of various hardware components and other features that may be used in accordance with aspects of the present disclosure. Aspects of the present disclosure may be implemented using hardware, software, or a combination thereof and may be implemented in one or more computer systems or other processing systems. In one example variation, aspects of the disclosure are directed toward one or more computer systems capable of carrying out the functionality described herein. An example of such a computer system 700 is shown in FIG. 7.

Computer system 700 includes one or more processors, such as processor 704. The processor 704 is connected to a communication infrastructure 706 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

Computer system 700 may include a display interface 702 that forwards graphics, text, and other data from the communication infrastructure 706 (or from a frame buffer not shown) for display on a display unit 730. Computer system 700 also includes a main memory 708, preferably random access memory (RAM), and may also include a secondary memory 710. The secondary memory 710 may include nonvolatile memory, for example, a hard disk drive 712, flash memory and/or a removable storage drive 714, representing a floppy disk drive, a magnetic tape drive, an optical disk drive, etc. The removable storage drive 714 reads from and/or writes to a removable storage unit 718 in a well-known manner. Removable storage unit 718, represents a USB memory drive, SD card, floppy disk, magnetic tape, optical disk, etc., which is read by and written to removable storage drive 714. As will be appreciated, the removable storage unit 718 includes a computer usable storage medium having stored therein computer software and/or data.

In alternative aspects, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728, which may be electronic, electromagnetic, optical or other signals capable of being received by communications interface 724. These signals 728 are provided to communications interface 724 via a communications path (e.g., channel) 726. This path 726 carries signals 728 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 714, a hard disk installed in hard disk drive 712, and signals 728. These computer program products provide software to the computer system 700. Aspects of the disclosure are directed to such computer program products.

Computer programs (also referred to as computer control logic) are stored in main memory 708 and/or secondary memory 710. Computer programs may also be received via communications interface 724. Such computer programs, when executed, enable the computer system 700 to perform various features in accordance with aspects of the present disclosure, as discussed herein. In particular, the computer programs, when executed, enable the processor 704 to perform such features. Accordingly, such computer programs represent controllers of the computer system 700.

In variations where aspects of the disclosure are implemented using software, the software may be stored in a computer program product and loaded into computer system 700 using removable storage drive 714, hard disk drive 712, or communications interface 720. The control logic (software), when executed by the processor 704, causes the processor 704 to perform the functions in accordance with aspects of the disclosure as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the disclosure are implemented using a combination of both hardware and software.

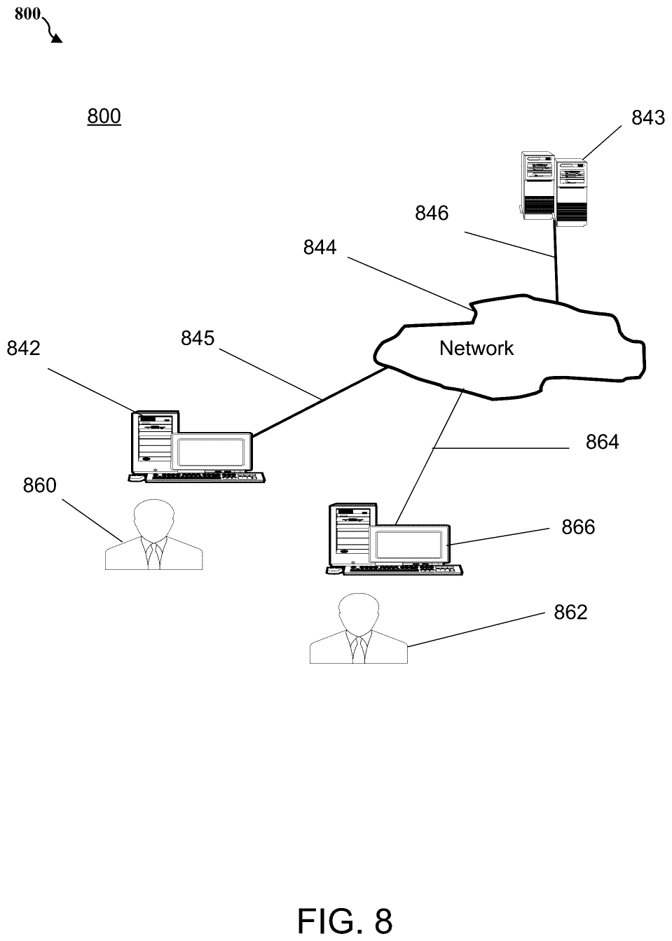

FIG. 8 is a block diagram of various example system components (e.g., on a network) that may be used in accordance with aspects of the present disclosure. The system 800 may include one or more accessors 860, 862 (also referred to interchangeably herein as one or more “users”) and one or more terminals 842, 866. In one aspect, data for use in accordance with aspects of the present disclosure may, for example, be input and/or accessed by accessors 860, 862 via terminals 842, 866, such as personal computers (PCs), minicomputers, mainframe computers, microcomputers, telephonic devices, or wireless devices, such as personal digital assistants (“PDAs”) or a hand-held wireless devices coupled to a server 843, such as a PC, minicomputer, mainframe computer, microcomputer, or other device having a processor and a repository for data and/or connection to a repository for data, via, for example, a network 844, such as the Internet or an intranet, and couplings 845, 846, 864. The couplings 845, 846, 864 include, for example, wired, wireless, or fiber optic links. In another example variation, the method and system in accordance with aspects of the present disclosure operate in a stand-alone environment, such as on a single terminal.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

The foregoing description, for purpose of explanation, has been with reference to specific aspects. However, the illustrative discussions above are not intended to be exhaustive or to limit the disclosure to the precise forms disclosed. M any modifications and variations are possible in view of the above teachings. The aspects were chosen and described in order to best explain the principles of the disclosure and its practical applications, to thereby enable others skilled in the art to best utilize the disclosure and various aspects with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present disclosure, for example, aspects of the innovations herein may be implemented consistent with numerous general purpose or special purpose computing systems or configurations. Various example computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The disclosure may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIM D instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the disclosure or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosure, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CM OS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the disclosure have been specifically described herein, it will be apparent to those skilled in the art to which the disclosure pertains that variations and modifications of the various implementations shown and described herein may be made without departing from the spirit and scope of the disclosure. Accordingly, it is intended that the disclosure be limited only to the extent required by the applicable rules of law.

While the foregoing has been with reference to a particular aspect of the disclosure, it will be appreciated by those skilled in the art that changes in this aspect may be made without departing from the principles and spirit of the disclosure, the scope of which is defined by the appended claims.

What is claimed is:

1. A computer-implemented method for performing a distributed join in a database system that includes multiple host devices, comprising:
accessing, by a first host device of the multiple host devices, a compute express link (CXL) memory to obtain data written to the CXL memory by at least a second host device of the multiple host devices; and
performing, by the first host device and based on the obtained data, the distributed join.

2. The computer-implemented method of claim 1, wherein the CXL memory includes a portion of memory for each host device of the multiple host devices.

3. The computer-implemented method of claim 2, wherein each portion of memory includes, for a given host device associated with the portion of memory, data access tables for each pair of host devices including the given host device and one of the other host devices, and wherein accessing the CXL memory to obtain the data is based on polling the portion of memory for the second host device to determine whether a write pointer in the data access table for the second host device for the pair of the first host device and the second host device matches a read pointer of the first host device.

4. The computer-implemented method of claim 2, wherein each portion of memory includes a parameter for locking the portion of memory, and wherein accessing the CXL memory to obtain the data is based on determining that the parameter for locking the portion of memory for the second host device is set to an unlocked value.

5. The computer-implemented method of claim 1, further comprising incrementing a reference counter during accessing of the CXL memory to obtain the data.

6. The computer-implemented method of claim 1, wherein accessing the CXL memory to obtain the data is based on detecting that a test condition indicating that the second host device has written to the CXL memory is successful.

7. The computer-implemented method of claim 1, wherein accessing the CXL memory to obtain the data is based on receiving a message from the second host device indicating that the second host device has written to the CXL memory.

8. The computer-implemented method of claim 1, wherein accessing the CXL memory includes obtaining the data from a buffer allocated, in the CXL memory, to the second host device.

9. The computer-implemented method of claim 1, wherein accessing the CXL memory includes copying a portion of contents of the CXL memory into a local memory of the first host device, and obtaining the data from the local memory.

10. The computer-implemented method of claim 1, wherein the distributed join corresponds to a repartition join, and wherein the obtained data corresponds to at least one build partition of multiple build partitions or at least one probe partition of multiple probe partitions using at least the obtained data based on a join key.

11. The computer-implemented method of claim 10, further comprising generating a local hash table on one or more of the multiple build partitions, and probing a matching one or more of the multiple probe partitions based on the local hash table.

12. The computer-implemented method of claim 10, further comprising probing one or more of the multiple build partitions by looping over the one or more of the multiple build partitions for each tuple in a matching one or more of the multiple probe partitions.

13. The computer-implemented method of claim 1, wherein the distributed join corresponds to a broadcast join, and wherein the obtained data corresponds to a broadcasted build relation generated based on the multiple hosts writing the data to the CXL memory, and further comprising probing the broadcasted build relation using one or more probe partitions.

14. The computer-implemented method of claim 13, further comprising generating, based on the broadcasted build relation, a local hash table, wherein probing the broadcasted build relation includes probing the one or more probe partitions against the local hash table.

15. The computer-implemented method of claim 13, wherein probing the broadcasted build relation is realized by looping over the broadcasted build relation for each tuple of the one or more probe partitions.

16. The computer-implemented method of claim 1, wherein the distributed join corresponds to a shared hash table join, and wherein the obtained data corresponds to a shared hash table generated based on the multiple hosts writing a respective portion of the shared hash table to the CXL memory, and further comprising probing one or more probe partitions against the shared hash table.

17. The computer-implemented method of claim 16, wherein writing, by the first host device, the respective portion of the shared hash table is based on verifying a synchronization mechanism.

18. A device for performing a distributed join in a database system that includes multiple host devices, comprising:
one or more memories configured to store instructions; and
one or more processors communicatively coupled with the one or more memories, wherein the one or more processors are configured to:
access a compute express link (CXL) memory to obtain data written to the CXL memory by at least a second device of the multiple host devices; and
perform, based on the obtained data, the distributed join.

19. The device of claim 18, wherein the CXL memory includes a portion of memory for each host device of the multiple host devices.

20. A computer-readable medium comprising code executable by one or more processors for performing a distributed join in a database system that includes multiple host devices, the code comprising code for:
accessing, by a first host device of the multiple host devices, a compute express link (CXL) memory to obtain data written to the CXL memory by at least a second host device of the multiple host devices; and
performing, by the first host device and based on the obtained data, the distributed join.
